(19) United States
(12) Patent Application Publication
(10) Pub. No.: US 2002/0142931 A1
(43) Pub. Date: Oct. 3, 2002

(54) Gel form automatic dishwashing compositions, methods of preparation and use thereof

(75) Inventors: Frank William DeNome, Cincinnati, OH (US); Elizabeth Ann Alam, West Chester, OH (US); Joseph Herbert Thien, Fairfield, OH (US)

Correspondence Address: THE PROCTER & GAMBLE COMPANY, PATENT DIVISION, MIAMI VALLEY LABORATORIES, P.O. BOX 538707, CINCINNATI, OH, 45253-8707, US

(73) Assignee: The Procter & Gamble Company

(21) Appl. No.: 09/906,295

(22) Filed: Jul. 16, 2001

(30) Foreign Application Priority Data
Nov. 27, 2000 (GB) 0028821.7
Jul. 25, 2000 (US) PCT/US00/20255
Jul. 19, 2000 (US) PCT/US00/19619
Dec. 21, 2000 (US) PCT/US00/34910
Dec. 21, 2000 (US) PCT/US00/34908

(51) Int. Cl. C11D 1/00

(52) U.S. Cl. 510/220; 510/221; 510/233

(57) ABSTRACT

An automatic dishwashing composition in the form of an anhydrous, shear-thinning organo solvent-based gel and which comprises a thickening system consisting essentially of non-ionic cellulosic material. A process for making such a composition is also provided. A preferred execution is an automatic dishwashing composition comprising from about 1% to about 99%, preferably from about 5% to about 90%, especially from about 40% to about 80% of an organic solvent system for removing cooked-, baked-, or burnt-on food soil from cookware and tableware, from about 0.5% to about 50%, preferably from about 5% to about 25% of bleach, from about 0.0001% to about 10% of detergency enzyme, and wherein the composition is in the form of an anhydrous gel comprising bleach in the form of a particulate suspension.

### TECHNICAL FIELD

The present invention is in the field of automatic dishwashing compositions, in particular it relates to dishwashing compositions in the form of anhydrous gels, especially gels comprising particulate material in the form of a suspension. The compositions have improved rheological and stability characteristics and are particularly useful for cleaning heavily soiled dishwashing loads and for the removal of cooked-, baked- and burnt-on soils. The invention also relates to multi-phase products comprising the anhydrous dishwashing compositions. The invention further relates to dishwashing products in unitised form, for example capsules, pouches, sachets, etc.

### BACKGROUND OF THE INVENTION

Dishwashing loads are usually characterised by including articles made of different materials (i.e. stainless steel, glass, plastic, wood, ceramic, china, porcelain, etc) and soiled with different food residues (i.e. proteinaceous, carbohydrates, grease, starch, carotenoids, etc). The removal of all the soils from the dishwashing load usually requires a combination of several detergent ingredients. However, in many cases not all the ingredients are compatible with one another and it can be a difficult or impossible task to combine and stabilise them into a single composition.

Cooked-, baked- and burnt-on soils are amongst the most severe types of soils to remove from surfaces. The use of cleaning compositions containing solvent for helping in the removal of cooked-, baked- and burnt-on solids is known in the art. For example, U.S. Pat. No. 5,102,573 provides a method for treating hard surfaces soiled with cooked-on, baked-on or dried-on food residues comprising applying a pre-spotting composition to the soiled article. The composition applied comprises surfactant, builder, amine and solvent. U.S. Pat. No. 5,929,007 provides an aqueous hard surface cleaning composition for removing hardened dried or baked-on grease soil deposits. The composition comprises nonionic surfactant, chelating agent, caustic, a glycol ether solvent system, organic amine and anti-redeposition agents. WO-A-94/28108 discloses an aqueous cleaner concentrate composition, that can be diluted to form a more viscous use solution comprising an effective thickening amount of a rod micelle thickener composition, lower alkyl glycol ether solvent and hardness sequestering agent. The application also describes a method of cleaning a food preparation unit having at least one substantially vertical surface having a baked food soil coating. In practice, however, none of the art has been found to be very effective in removing baked-on, polymerized soil from metal and other substrates.

The use of solvents in the automatic dishwashing context is also known. JP-A-10,017,900 discloses an automatic dishwashing auxiliary composition comprising non-ionic low foaming surfactant, organic solvent and water. The composition delivers detergency and drying benefits. JP-A-11,117,000 discloses a cleaning assistant composition for automatic dishwashing machines comprising surfactant, organic high-molecular polyelectrolyte, water-soluble solvent and water. The claimed assistant composition helps in the cleaning of stubborn dirt such as that due to oil or lipstick.

It is also known to use chlorine and peroxygen bleaches in automatic dishwashing to remove coloured stains such as tea and coffee and carotenoids stains. Chlorine bleaches are invariably the bleaches of choice in aqueous liquid products because they have much better stability than peroxygen bleaches. Peroxygen bleaches have the advantage over chlorine bleaches of greater compatibility with enzymes and of being suitable for use under lower alkalinity wash conditions. The incorporation of particulate peroxygen bleaches in stable liquid compositions raises considerable difficulties however.

In these and other cases, it would be advantageous to include both solid and liquid ingredients in detergent compositions; for example, it would be very useful to have a liquid detergent comprising cleaning solvent and particulate peroxygen bleach. A liquid composition comprising solid ingredients must be chemically and physically stable. Ideally, the liquid should be capable of homogeneously suspending the particles without reacting with them. A liquid composition comprising peroxygen bleach should be anhydrous in order to prevent bleach decomposition due to bleach/water interaction. Another factor that should be taken into account, when formulating liquid compositions comprising solid ingredients, is that the compositions should have the right rheology in order to provide a product easy to pour and at the same time should be thick enough so it will not leak from the dishwasher dispenser.

The use of anhydrous compositions containing suspended particulate solids is known in the art. EP-A-266,199 discloses non-aqueous liquid cleaning products formulated by dispersing particulate solids in an organic solvent by using a structurant or deflocculant which causes a viscosity reduction at low shear rates in the solids/solvent system or an equivalent system in which the solids volume fraction is sufficiently high to raise the viscosity of the solvent. The organic solvent is preferably a liquid surfactant. The solids are any usable in liquid cleaning products, including detergency builders and bleaches. The structurants are Bronsted or Lewis acids. U.S. Pat. No. 5,872,092 discloses nonaqueous, peroxygen bleach-containing liquid laundry detergent compositions in the form of a suspension of particulate material. The liquid phase contains an alcohol ethoxylate nonionic surfactant and a nonaqueous low polarity organic solvent while the compositions may additionally contain a thickening, viscosity control and/or dispersing agent selected from acrylic acid-based polymers. U.S. Pat. No. 5,164,106 discloses nonaqueous liquid automatic dishwasher detergent composition containing a dual bleach system, the dual bleach system being a chlorine bleach source and a bromide compound.

Thus, there is a need for a dishwashing detergent composition which is effective against all kinds of soils including cooked-, baked- and burnt-on soils as well as coloured stains and other bleachable and enzyme sensitive soils without the need to pretreat heavily soiled items or to use dishwashing additives. There is also a need for a detergent in the form of a particulate suspension in which segregation or separation of solid particles does not occur and which is easy to pour and does not leak from the dishwasher dispenser.

Sometimes it is desirable to have a dual or multi-phase detergent system comprising an anhydrous and an aqueous composition which are simultaneously or sequentially delivered into the dishwasher. Such multi-phase systems allow further refinement in dishwashing performance and can provide superior overall end result. Problems in the delivery of multi system compositions may arise when the different compositions have different viscosity characteristics. Therefore, it is another objective of the present invention to provide multi composition systems with matched rheology in order to allow for an easy simultaneous and controlled delivery of the system compositions.

Unitised doses of dishwashing detergents are found to be more attractive and convenient to some consumers because they avoid the need of the consumer to measure the product thereby giving rise to a more precise dosing and avoiding wasteful overdosing or underdosing. For this reason automatic dishwashing detergent products in tablet form have become very popular. Detergent products in unitised form such as pouches, capsules and sachets are also known in the art and are preferred by some users from the viewpoint of minimizing handling and contact of the detergent product with the user's skin and for avoiding inhalation of product vapors. Such products are prone to a number of additional problems, however. For example, in the case of pouches, sachets and capsules containing a peroxygen bleach-based detergent and having an outer wall material made of a moisture permeable material, bleach decomposition can give rise to bloating or even destruction of the outer wall of the product due to the generation of gaseous oxygen. Thus there is a need for unitised forms which deliver both improved cleaning performance together with good chemical and physical product stability.

### SUMMARY OF THE INVENTION

According to a first aspect of the present invention, there is provided an automatic dishwashing composition in the form of an anhydrous, shear-thinning organo solvent-based gel and which comprises a thickening system consisting essentially of non-ionic cellulosic material.

The compositions herein take the form of an essentially anhydrous gel. By “essentially anhydrous” is meant that they contain less than about 5%, preferably less than about 1% free moisture. Highly preferred, however, are compositions which contain less than about 0.5%, more preferably less than about 0.1% and ever more preferably less than about 0.05% free moisture.

Anhydrous compositions with free moisture levels below 0.1% are particularly suitable for the inclusion of moisture sensitive components. It will be understood that additional water can be present in the anhydrous composition forming part of hydrated compounds, i.e. bound water. It should also be understood that although the composition should contain less than about 0.5, preferably less than 0.1 and even more preferably less than 0.05% by weight of the composition of free water at the time of manufacture, the water content could increase if the composition is exposed to the environment. For example if the composition is placed in a bottle and the bottle is left open for a period of time, the composition could pick up moisture from the surrounding environment. Preferably, however, the compositions for use herein are not hygroscopic and will be stored under moisture-tight conditions so that they will not tend to pick up water from the surroundings. Free moisture can be measured by extracting 2 g of the product into 50 ml of dry methanol at room temperature for 20 minutes and then analysis a 1 ml aliquot of the methanol by Karl Fischer titration.

The matrix of the gel comprises an organic solvent system (which term is understood to include both single and mixed organo solvent compounds). Solvents preferred herein from the viewpoint of forming an anhydrous shear-thinning gel and of providing homogeneous stable suspensions are organic solvents having: a fractional polar Hansen solubility parameter from about 10% to about 40% and a fractional dispersion Hansen solubility parameter from about 20% to about 60%. Fractional polar Hansen solubility parameter of a solvent is defined as the ratio (multiplied by 100) of the polar Hansen solubility parameter to the sum of the dispersion, polar and hydrogen bonding Hansen solubility parameters. Fractional dispersion Hansen solubility parameter of a solvent is defined as the ratio (multiplied by 100) of the dispersion Hansen solubility parameter to the sum of the dispersion, polar and hydrogen bonding Hansen solubility parameters. Fractional hydrogen bonding Hansen solubility parameter of a solvent is defined as the ratio (multiplied by 100) of the hydrogen bonding Hansen solubility parameter to the sum of the dispersion, polar and hydrogen bonding Hansen solubility parameters. Preferably organic solvents for use herein additionally provide a cleaning function. Especially suitable for use herein are organic solvents whose fractional polar, dispersion and hydrogen bonding Hansen solubility parameters fall within the area defined by a quadrilateral having four vertices given by the following co-ordinates: (18, 50, 33), (10, 51, 38), (20, 25, 57) and (38, 20, 43) as plotted on a triangular diagram of Hansen solubility parameter with axes scaled between 0 and 100% (the first, second and third coordinates correspond to fractional polar, dispersion and hydrogen bonding Hansen solubility parameters, respectively). Examples of suitable solvents for use herein include: 2-amino 2-methyl 1-propanol, dipropylene glycol, dipropylene glycol methyl ether, propanediol, monoethanolamine, di-ethyl glycol, glycerol, benzyl alcohol, polyethylene glycol solvents and mixtures thereof.

The compositions herein display excellent stability characteristics and absence of syneresis. Without wishing to be bound by theory, it is believed that for optimum stability performance, the thickening system should be soluble in the solvent system and the anhydrous gel matrix. Most of the traditional thickener materials used in liquid detergents are insoluble or at least only swellable in typical organo solvent systems, for example polymeric thickener materials and clays. It has now been found however that cellulosic type thickeners, especially non-ionic cellulosic materials are highly suitable in conjunction with organo solvents as defined for providing stable anhydrous gels and suspensions with little or no syneresis. Suitable thickener materials for use herein include hydroxyethyl and hydroxymethyl cellulose (ETHOCEL and METHOCEL® available from Dow Chemical), hydroxpropyl cellulose (Klucel H and Klucel M) and mixtures thereof. Preferably, the thickener system used herein is in levels of from about 0.05% to about 2%, preferably from about 0.1% to about 1% and more preferably from about 0.2% to about 0.6% by weight of the composition. Suitable thickening systems for use herein comprise at least about 50%, preferably at least about 80%, more preferably at least about 95% and especially at least about 99% of said non-ionic cellulosic material and are essentially free of clay-type thickener materials or other thickener materials which are insoluble in the gel matrix.

Thus, according to another aspect of the invention, there is provided an automatic dishwashing composition in the form of an anhydrous, shear-thinning organo solvent-based gel comprising a soluble thickening system and wherein the organo solvent has a fractional polar Hansen solubility parameter from about 10% to about 40% and a fractional dispersion Hansen solubility parameter from about 20% to about 60%. The compositions herein are highly suited to the preparation of stable suspensions.

Although Stokes' law is strictly applicable to a single particle in an infinite fluid, this law can help to qualitatively understand and predict the stability of a suspension. From Stokes' law the terminal velocity of a particle in an infinite fluid, uₜ (m/s) can be calculated as follows:

$${u}_{t} = \frac{{d}_{p}^{2} g ( {ρ}_{p} - {ρ}_{f} )}{18 μ}$$

where dₚ (m) is the particle diameter, g (m/s²) is the gravity constant, ρₚ (kg/m³) is the particle density, ρ_{f} (kg/m³) is the fluid density and μ(kg/m s) is the fluid viscosity. A perfectly stable suspension is that in which the terminal velocity of the particle in the given fluid is zero. Terminal velocity is determined by three variables, dₚ, (ρₚ−ρ_{f}) and μ. The stability of a suspension increases as the viscosity increases, as the particle diameter decreases and as the difference between the liquid and the particle density decreases. The density difference between the particle and the liquid is fixed by the raw materials used. An increase in viscosity is achieved by the use of thickener agents. In shear-thinning systems, however, viscosity reduces under shear and leads to an increase in terminal velocity. The efficacy of the thickening systems utilized herein at levels of less than 1% with substantial absence of syneresis would suggest that they are uniquely effective in the way they behave under the application and removal of shear forces. Such efficacy is particularly important for producing compositions which are easy to pour and capable of being retained in a closed dishwasher dispenser as well as easy to flow once the dispenser is opened. These requirements are herein fulfilled by the use of the shear-thinning gel compositions of the invention.

Thus according to another embodiment of the present invention there is provided an automatic dishwashing composition in the form of an anhydrous shear-thinning solvent-based gel and which comprises a detergent active or auxiliary in the form of a particulate suspension. Suitable organic solvents for use herein should be capable of suspending particulate material without reacting with it. The suspension should be stable in order to avoid a substantial separation of phases with time. Herein a suspension is considered to be stable when no visual phase separation can be observed after 30 days at 48° C.

In a preferred embodiment the cleaning composition comprises particulate material having an average particle size from about 10 to about 100 μm, preferably from about 25 to about 75 μm and preferably having less than 10% of particles below about 1 μm, more preferably below about 5 μm and less than 10% of particles above about 150 μm, more preferably above about 100 μm. Particle size is measured using a particle size analyser based on laser diffraction. This particle size distribution has been found especially suitable for the particles to form a stable suspension in the organo solvent-based gels used herein.

Preferably the particulate material comprises a detergent active or auxiliary selected from bleaches, bleach activators, enzymes, alkalinity sources, builders, surfactants and mixtures thereof. Preferred compositions are those wherein the particulate material comprises a peroxygen bleaching agent and optionally an activator therefor. The bleaching agent can be selected from inorganic peroxides inclusive of perborates and percarbonates, organic peracids inclusive of preformed monoperoxy carboxylic acids, such as phthaloyl amido peroxy hexanoic acid, and di-acyl peroxides.

It is believed that bleach decomposition (probably due to bleaching agents reacting with traces of water) is mainly a self-catalytic process catalysed by the free radicals generated from the decomposition process. Preferably, the composition of the invention comprises a free radical scavenger, for reducing or stopping the bleach decomposition, selected from benzoic acids, sulfobenzenes and mixtures thereof.

Preferably the enzymes for use herein are enzyme prills having an average particle size smaller than about 100 μm, preferably smaller than about 75 μm and even more preferably smaller than about 50 μm. Alternatively, the enzymes could be in the form of a liquid anhydrous slurry stock.

In a preferred embodiment the composition of the invention is in the form of a shear thinning fluid having a shear index (n) (Herschel-Bulkey model) of from about 0 to about 0.8, preferably from about 0.3 to about 0.7, more preferably from about 0.4 to about 0.6. The fluid consistency index (K), on the other hand, can vary from about 0.1 to about 50 Pa.sⁿ. The shear index and consistency index are calculated (in S.I. units) using Herschel-Bulkey equation:

τ=τ_{y}+Kγⁿ

The shear stress (τ) is experimentally measured at different shear rate (γ) values (in the range from about 1 s⁻¹ and 150 s⁻¹), the yield stress (τ_{y}) is calculated from experimental measurements, as described herein below, and shear stress, shear rate and yield stress are substituted into the equation and the shear index and consistency index are calculated. Rheology data is recorded at 25° C.

Especially useful for use herein are compositions having a viscosity greater than about 8,000 cP (mPa s), preferably greater than 10,000 cP (mPa s), more preferably greater than 15,000 cP (mPa s) as measured at a shear rate of 1 s⁻¹ and a viscosity less than about 5,000 cP (mPa s), preferably less than 2,000 cP (mPa s), more preferably less than 1,000 cP (mPa s) as measured at a shear rate of 150 s⁻¹ using the Rheometer described below. In addition, the compositions of the invention preferably have a yield stress of from about 5 to about 50 Pa, preferably from about 10 to about 40 Pa and more preferably from about 15 to about 25 Pa. Rheological data is obtained using a Rheometrics Dynamic Stress Rheometer with 40 mm parallel plate configuration, the plate gap being 0.9 mm and the shear stress ramp being from 0 to 60 Pa. To measure yield stress, shear stress is measured as a function of shear rate in the region up to about 1 s⁻¹. Shear rate/shear stress (Y-axis) versus shear stress (X-axis) is plotted. On the plot, a line tangent to the X-axis is drawn through the portion of the curve that is also parallel to the X-axis. The yield stress is the point where the plotted curve breaks from the tangent line.

Preferably, the composition used herein comprises from about 10% to about 90%, more preferably from about 20% to about 70% and more preferably from about 25% to about 55% and especially from about 30% to about 35% of solvent by weight of composition, although solvent levels outside these ranges are also envisaged.

It is a feature of the invention that the anhydrous gel compositions provide good stability and compatibility of both bleaches and enzymes. Thus according to another aspect of the invention there is provided an organic solvent composition suitable for use in automatic dishwashing comprising from about 1% to about 99%, preferably from about 5% to about 90%, especially from about 25% to about 80% and more especially from about 40% to about 55% of an organic solvent system for removing cooked-, baked-, or burnt-on food soil from cookware and tableware, from about 0.5% to about 50%, preferably from about 5% to about 25% of bleach, from about 0.0001% to about 10% of detergency enzyme, and wherein the composition is in the form of an anhydrous gel comprising bleach in the form of a particulate suspension.

Some of the organic solvents suitable for use herein have an odor which is perceived by some consumers as unpleasant. In order to improve the odor perceived for the user in preferred embodiments an odor masking perfume can be introduced into the composition.

The effect of the solvent system can be further improved by the addition of certain wetting agents. Preferably, the organic solvent system is used in conjunction with a wetting agent effective in lowering the surface tension of the solvent system, preferably to at least 1 mN/m less than that of the wetting agent. The wetting agent itself is preferably selected from organic surfactants having a surface tension less than about 30 mN/m, more preferably less than about 28 mN/m and specially less than about 26 mN/m. Preferred wetting agents for use herein are silicone polyether copolymers, especially silicone poly(alkyleneoxide) copolymers wherein alkylene is selected from ethylene, propylene and mixtures thereof.

The compositions preferably have a pH (1% aqueous solution) in excess of about 9.0, preferably in excess of about 10.5 and more preferably greater than about 11. Even more preferred are compositions having a pH greater than about 11.5, preferably greater than about 12 and more preferably greater than about 12.5 measured at 25° C.

A suitable way to deliver the compositions of the invention is by means of a unit dose product such as a water soluble capsule, pouch or sachet. Thus, in a preferred embodiment of the invention there is provided an automatic dishwashing product in the form of a capsule, pouch or sachet comprising an amount and preferably a unit dose amount of the dishwashing compositions of the invention.

According to another aspect of the invention there is provided a multi-phase automatic dishwashing product comprising separated but associated portions of an anhydrous composition as described hereinabove and an aqueous composition comprising one or more detergency actives or detergency auxiliaries. Preferably, the aqueous composition comprises form about 25 to about 50%, preferably form about 30 to about 40% of solids by weight of the composition. The composition can also comprise one or more detergency enzymes, non-ionic surfactants, perfumes and thickeners. The pH of the aqueous composition is preferably from about 8 to about 12, more preferably from about 9 to 11 and even more preferably from about 9 to 9.8 measured at 25° C.

In a preferred embodiment the multi-phase cleaning product is contained and delivered from separate zones of a multi-zone storage means such as a multi-compartment bottle or pouch. The anhydrous and the aqueous phases are stored in different compartments but they can be simultaneously delivered at the same or different flowrate. Alternatively they can be delivered in phased or sequential fashion. In the case of multi-phase compositions delivered at the same flowrate it is desirable to match the rheology of the various compositions. Compositions are considered to be rheology matched if they have similar yield stress (differing by less than about 50%, preferably by less than about 20%) and/or similar viscosities (differing by less than about 50%, preferably by less than about 20%) under the same shear conditions (especially at 1 s⁻¹ and 150 s⁻¹). Preferably also, the various compositions will have similar shear indices (differing by less than about 50%, preferably by less than about 20%).

Finally, there is also provided a method for making the anhydrous dishwashing compositions described herein and which comprise a detergent active or auxiliary in the form of a particulate suspension. The method comprises the steps of:

a) mixing the organo solvent with the thickener system to form a shear-thinning anhydrous carrier matrix;

b) milling the particulate material in a size reduction equipment to an average particle size from about 10 to about 100 μm, preferably from about 25 to about 75 μm and wherein less than 10% of particles are below about 1 μm, preferably below about 5 μm and less than 10% of particles are above about 150 μm, preferably above about 100 μm; and

c) thereafter mixing the products of steps a) and b) to obtain a physically stable suspension.

There is also provided a method of washing cookware/tableware in an automatic dishwashing machine using the compositions described herein.

### DETAILED DESCRIPTION OF THE INVENTION

The present invention envisages an automatic dishwashing composition in the form of an anhydrous, shear-thining organo solvent-based gel. It also envisages anhydrous dishwashing compositions in the form of a particulate suspension. Especially useful are automatic dishwashing suspensions comprising an organic solvent, having a cleaning functionality, and a particulate peroxygen bleach. This will fulfil the consumer desire of being able to clean in an automatic dishwashing machine all kind of soils from all kind of cookware and tableware with a single detergent composition without the need of pretreatment of the soiled articles.

The present invention also envisages a multi-phase product comprising anhydrous and aqueous compositions and storage means comprising separate but associated portions of the compositions. Finally, the invention also envisages a method for making the anhydrous composition in the form of a suspension. The method provides a chemically and physically stable suspension.

The cleaning compositions herein comprise an organo solvent and a thickener system and can additionally comprise bleach, enzyme, alkalinity source, builder, surfactant, free radical scavenger, etc.

Organic Solvent

The organic solvent system can simply act as a liquid carrier, but in preferred compositions, the solvent is capable of removing cooked-, baked- or baked-on soils from substrates and thus has detergent functionality in its own right. Organoamine solvents are particularly beneficial in this respect. In general terms, organic solvents for use herein should be selected so as to be compatible with the tableware/cookware as well as with the different parts of an automatic dishwashing machine. Furthermore, the solvent system (comprising a single solvent compound or a mixture of solvent compounds) should be effective and safe to use having a volatile organic content above 1 mm Hg (and preferably above 0.1 mm Hg) of less than about 50%, preferably less than about 20%, more preferably less than about 10% and even more preferably less than about 4% by weight of the solvent system. Herein volatile organic content of the solvent system is defined as the content of organic components in the solvent system having a vapor pressure higher than the prescribed limit at 25° C. and atmospheric pressure. The individual organic solvents used herein generally have a boiling point above about 150° C., flash point above about 50° C., preferably above 100° C. and vapor pressure below about 1 mm Hg, preferably below 0.1 mm Hg at 25° C. and atmospheric pressure. In addition, the individual organic solvents preferably have a molar volume of less than about 500, preferably less than about 250, more preferably less than about 200 cm³/mol, these molar volumes being preferred from the viewpoint of providing optimum soil penetration and swelling. In highly preferred embodiments, the solvent is essentially free (contains less than about 5% by weight) of solvent components having a boiling point below about 150° C., flash point below about 100° C. or a vapor pressure above about 1 mm Hg at 25° C. and atmospheric pressure.

A broad range of organic solvents are suitable for use herein but preferably the organic solvent is selected from alcohols, amines, esters, glycol ethers, glycols, terpenes and mixtures thereof. The organic solvent system is preferably selected from organoamine solvents, inclusive of alkanolamines, alkylamines, alkyleneamines and mixtures thereof; alcoholic solvents inclusive of aromatic, aliphatic (preferably C₄-C₁₀) and cycloaliphatic alcohols and mixtures thereof; glycols and glycol derivatives inclusive of C₂-C₃ (poly)alkylene glycols, glycol ethers, glycol esters and mixtures thereof; and mixtures selected from organoamine solvents, alcoholic solvents, and glycols and glycol derivatives. In one preferred embodiment the organic solvent comprises organoamine (especially alkanolamine, more especially 2-aminalkanol) solvent and glycol ether solvent, preferably in a weight ratio of from about 3:1 to about 1:3, and wherein the glycol ether solvent is selected from ethylene glycol monobutyl ether, diethylene glycol monobutyl ether, ethylene glycol monomethyl ether, ethylene glycol monoethyl ether, diethylene glycol monomethyl ether, diethylene glycol monoethyl ether, propylene glycol monobutyl ether, dipropylene glycol, dipropylene glycol methyl ether, and mixtures thereof. Preferably, the glycol ether is a mixture of diethylene glycol monobutyl ether and propylene glycol butyl ether, especially in a weight ratio of from about 1:2 to about 2:1. In other preferred embodiments, the organic solvent or solvent system is selected from C₂-C₃ alkylene, dialkylene, trialkylene and polyalkylene glycols, glycol ethers and esters and mixtures thereof. Of these, the polyalkylene glycols inclusive of polyethylene glycols having an average molecular weight in the range from about 200 to about 700, preferably from about 250 to about 600 are preferred in the context of capsule and pouch products and especially water-soluble partially hydrolysed PVA-based peroxygen bleach-containing capsule and pouch products from the viewpoint of providing excellent product stability, both chemical and physical, together with good cleaning performance on baked-on soils.

The optimum concentration of the solvent in the wash liquor from the viewpoint of achieving good cleaning performance on cooked-, baked- and burnt-on soils is from about 100 ppm to about 10000 ppm, preferably from about 200 to about 8000 and more preferably from about 500 to about 5000 ppm.

Surfactant

In the composition of the present invention for use in automatic dishwashing the detergent surfactant is preferably low foaming by itself or in combination with other components (i.e. suds suppressers). Surfactants suitable herein include anionic surfactants such as alkyl sulfates, alkyl ether sulfates, alkyl benzene sulfonates, alkyl glyceryl sulfonates, alkyl and alkenyl sulphonates, alkyl ethoxy carboxylates, N-acyl sarcosinates, N-acyl taurates and alkyl succinates and sulfosuccinates, wherein the alkyl, alkenyl or acyl moiety is C₅-C₂₀ , preferably C₁₀-C₁₈ linear or branched; cationic surfactants such as chlorine esters (U.S. Pat. No. 4,228,042, U.S. Pat. No. 4,239,660 and U.S. Pat. No. 4,260,529) and mono C₆-C₁₆ N-alkyl or alkenyl ammonium surfactants wherein the remaining N positions are substituted by methyl, hydroxyethyl or hydroxypropyl groups; low and high cloud point nonionic surfactants and mixtures thereof including nonionic alkoxylated surfactants (especially ethoxylates derived from C₆-C₁₈ primary alcohols), ethoxylated-propoxylated alcohols (e.g., BASF's Poly-Tergent® SLF18), epoxy-capped poly(oxyalkylated) alcohols (e.g., BASF's Poly-Tergent® SLF18B—see WO-A-94/22800), ether-capped poly(oxyalkylated) alcohol surfactants, and block polyoxyethylene-polyoxypropylene polymeric compounds such as PLURONIC®, REVERSED PLURONIC®, and TETRONIC® by the BASF-Wyandotte Corp., Wyandotte, Mich.; amphoteric surfactants such as the C₁₂-C₂₀ alkyl amine oxides (preferred amine oxides for use herein include lauryldimethyl amine oxide and hexadecyl dimethyl amine oxide), and alkyl amphocarboxylic surfactants such as Miranol™ C2M; and zwitterionic surfactants such as the betaines and sultaines; and mixtures thereof. Surfactants suitable herein are disclosed, for example, in U.S. Pat. No. 3,929,678 , U.S. Pat. No. 4,259,217, EP-A-0414 549, WO-A-93/08876 and WO-A-93/08874. Surfactants are typically present at a level of from about 0.2% to about 30% by weight, more preferably from about 0.5% to about 10% by weight, most preferably from about 1% to about 5% by weight of composition. Preferred surfactants for use herein are low foaming and include low cloud point nonionic surfactants and mixtures of higher foaming surfactants with low cloud point nonionic surfactants which act as suds suppresser therefor.

Builder

Builders suitable for use in detergent and cleaning compositions herein include water-soluble builders such as citrates, carbonates and polyphosphates e.g. sodium tripolyphosphate and sodium tripolyphosphate hexahydrate, potassium tripolyphosphate and mixed sodium and potassium tripolyphosphate salts; and partially water-soluble or insoluble builders such as crystalline layered silicates (EP-A-0164514 and EP-A-0293640) and aluminosilicates inclusive of Zeolites A, B, P, X, HS and MAP. The builder is typically present at a level of from about 1% to about 80% by weight, preferably from about 10% to about 70% by weight, most preferably from about 20% to about 60% by weight of composition.

Amorphous sodium silicates having an SiO₂:Na₂O ratio of from 1.8 to 3.0, preferably from 1.8 to 2.4, most preferably 2.0 can also be used herein although highly preferred from the viewpoint of long term storage stability are compositions containing less than about 22%, preferably less than about 15% total (amorphous and crystalline) silicate.

Enzyme

Enzymes suitable herein include bacterial and fungal cellulases such as Carezyme and Celluzyme (Novo Nordisk A/S); peroxidases; lipases such as Amano-P (Amano Pharmaceutical Co.), M1 Lipase^{R} and Lipomax^{R} (Gist-Brocades) and Lipolase^{R} and Lipolase Ultra^{R} (Novo); cutinases; proteases such as Esperase^{R}, Alcalase^{R}, Durazym^{R} and Savinase^{R} (Novo) and Maxatase^{R}, Maxacal^{R}, Properase^{R} and Maxapem^{R} (Gist-Brocades); and α and β amylases such as Purafect Ox Am^{R} (Genencor) and Termamyl^{R}, Ban^{R}, Fungamyl^{R}, Duramyl^{R}, and Natalase^{R} (Novo); and mixtures thereof. Enzymes are preferably added herein as prills, granulates, or cogranulates at levels typically in the range from about 0.0001% to about 2% pure enzyme by weight of composition.

Bleaching Agent

Bleaching agents suitable herein include oxygen bleaches, especially inorganic perhydrate salts such as sodium perborate mono-and tetrahydrates and sodium percarbonate optionally coated to provide controlled rate of release (see, for example, GB-A-1466799 on sulfate/carbonate coatings), preformed organic peroxyacids and mixtures thereof with organic peroxyacid bleach precursors and/or transition metal-containing bleach catalysts (especially manganese or cobalt). Inorganic perhydrate salts are typically incorporated at levels in the range from about 1% to about 40% by weight, preferably from about 2% to about 30% by weight and more preferably from abut 5% to about 25% by weight of composition. Peroxyacid bleach precursors preferred for use herein include precursors of perbenzoic acid and substituted perbenzoic acid; cationic peroxyacid precursors; peracetic acid precursors such as TAED, sodium acetoxybenzene sulfonate and pentaacetylglucose; pemonanoic acid precursors such as sodium 3,5,5-trimethylhexanoyloxybenzene sulfonate (iso-NOBS) and sodium nonanoyloxybenzene sulfonate (NOBS); amide substituted alkyl peroxyacid precursors (EP-A-0170386); and benzoxazin peroxyacid precursors (EP-A-0332294 and EP-A-0482807). Bleach precursors are typically incorporated at levels in the range from about 0.5% to about 25%, preferably from about 1% to about 10% by weight of composition while the preformed organic peroxyacids themselves are typically incorporated at levels in the range from 0.5% to 25% by weight, more preferably from 1% to 10% by weight of composition. Bleach catalysts preferred for use herein include the manganese triazacyclononane and related complexes (U.S. Pat. No. 4,246,612, U.S. Pat. No. 5,227,084); Co, Cu, Mn and Fe bispyridylamine and related complexes (U.S. Pat. No. 5,114,611); and pentamine acetate cobalt(III) and related complexes(U.S. Pat. No. 4,810,410).

Low cloud point non-ionic surfactants and suds suppressers

The suds suppressers suitable for use herein include nonionic surfactants having a low cloud point. “Cloud point”, as used herein, is a well known property of nonionic surfactants which is the result of the surfactant becoming less soluble with increasing temperature, the temperature at which the appearance of a second phase is observable is referred to as the “cloud point” (See Kirk Othmer, pp. 360-362). As used herein, a “low cloud point” nonionic surfactant is defined as a nonionic surfactant system ingredient having a cloud point of less than 30° C., preferably less than about 20° C., and even more preferably less than about 10° C., and most preferably less than about 7.5° C. Typical low cloud point nonionic surfactants include nonionic alkoxylated surfactants, especially ethoxylates derived from primary alcohol, and polyoxypropylene/polyoxyethylene/polyoxypropylene (PO/EO/PO) reverse block polymers. Also, such low cloud point nonionic surfactants include, for example, ethoxylated-propoxylated alcohol (e.g., BASF's Poly-Tergent® SLF18) and epoxy-capped poly(oxyalkylated) alcohols (e.g., BASF's Poly-Tergent® SLF18B series of nonionics, as described, for example, in U.S. Pat. No. 5,576,281).

Preferred low cloud point surfactants are the ether-capped poly(oxyalkylated) suds suppresser having the formula:

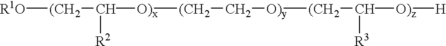

wherein R¹ is a linear, alkyl hydrocarbon having an average of from about 7 to about 12 carbon atoms, R² is a linear, alkyl hydrocarbon of about 1 to about 4 carbon atoms, R³ is a linear, alkyl hydrocarbon of about 1 to about 4 carbon atoms, x is an integer of about 1 to about 6, y is an integer of about 4 to about 15, and z is an integer of about 4 to about 25.

Other low cloud point nonionic surfactants are the ether-capped poly(oxyalkylated) having the formula:

R_{I}O(R_{II}O)ₙCH(CH₃)OR_{III}

wherein, R_{I} is selected from the group consisting of linear or branched, saturated or unsaturated, substituted or unsubstituted, aliphatic or aromatic hydrocarbon radicals having from about 7 to about 12 carbon atoms; R_{II} may be the same or different, and is independently selected from the group consisting of branched or linear C₂ to C₇ alkylene in any given molecule; n is a number from 1 to about 30; and R_{III} is selected from the group consisting of:

(i) a 4 to 8 membered substituted, or unsubstituted heterocyclic ring containing from 1 to 3 hetero atoms; and

(ii) linear or branched, saturated or unsaturated, substituted or unsubstituted, cyclic or acyclic, aliphatic or aromatic hydrocarbon radicals having from about 1 to about 30 carbon atoms;

(b) provided that when R is (ii) then either: (A) at least one of R¹ is other than C₂ to C₃ alkylene; or (B) R² has from 6 to 30 carbon atoms, and with the further proviso that when R² has from 8 to 18 carbon atoms, R is other than C₁ to C₅ alkyl.

Other suitable components herein include organic polymers having dispersant, anti-redeposition, soil release or other detergency properties invention in levels of from about 0.1% to about 30%, preferably from about 0.5% to about 15%, most preferably from about 1% to about 10% by weight of composition. Preferred anti-redeposition polymers herein include acrylic acid containing polymers such as Sokalan PA30, PA20, PA15, PA10 and Sokalan CP10 (BASF GmbH), Acusol 45N, 480N, 460N (Rohm and Haas), acrylic acid/maleic acid copolymers such as Sokalan CP5 and acrylic/methacrylic copolymers. Preferred soil release polymers herein include alkyl and hydroxyalkyl celluloses (U.S. Pat. No. 4,000,093), polyoxyethylenes, polyoxypropylenes and copolymers thereof, and nonionic and anionic polymers based on terephthalate esters of ethylene glycol, propylene glycol and mixtures thereof.

Heavy metal sequestrants and crystal growth inhibitors are suitable for use herein in levels generally from about 0.005% to about 20%, preferably from about 0.1% to about 10%, more preferably from about 0.25% to about 7.5% and most preferably from about 0.5% to about 5% by weight of composition, for example diethylenetriamine penta (methylene phosphonate), ethylenediamine tetra(methylene phosphonate) hexamethylenediamine tetra(methylene phosphonate), ethylene diphosphonate, hydroxy-ethylene-1,1-diphosphonate, nitrilotriacetate, ethylenediaminotetracetate, ethylenediamine-N,N′-disuccinate in their salt and free acid forms.

The compositions herein can contain a corrosion inhibitor such as organic silver coating agents in levels of from about 0.05% to about 10%, preferably from about 0.1% to about 5% by weight of composition (especially paraffins such as Winog 70 sold by Wintershall, Salzbergen, Germany), nitrogen-containing corrosion inhibitor compounds (for example benzotriazole and benzimadazole—see GB-A-1137741) and Mn(II) compounds, particularly Mn(II) salts of organic ligands in levels of from about 0.005% to about 5%, preferably from about 0.01% to about 1%, more preferably from about 0.02% to about 0.4% by weight of the composition.

Other suitable components herein include colorants, water-soluble bismuth compounds such as bismuth acetate and bismuth citrate at levels of from about 0.01% to about 5%, enzyme stabilizers such as calcium ion, boric acid, propylene glycol and chlorine bleach scavengers at levels of from about 0.01% to about 6%, lime soap dispersants (see WO-A-93/08877), suds suppressors (see WO-93/08876 and EP-A-0705324), polymeric dye transfer inhibiting agents, optical brighteners, perfumes and fillers.

Unitised dose forms especially useful for use herein are water-soluble, dispersible or frangible pouches, sachets, and capsules which can be made in known manner, for example from extruded films or by blow-, injection- or rotary moulding. Highly preferred herein are water-soluble pouches. The pouch herein is typically a closed structure which comprises one or more compartments, made of materials described herein. Subject to the constraints of dispenser fit, the pouch can be of any form, shape and material which is suitable to hold the composition, e.g. without allowing the release of the composition from the pouch prior to contact of the pouch to water. The exact execution will depend on, for example, the type and amount of the composition in the pouch, the number of compartments in the pouch, the characteristics required from the pouch to hold, protect and deliver or release the composition and/or components thereof.

The pouch or capsule is preferably made of a material which is soluble or dispersible in water, and has a water-solubility of at least 50%, preferably at least 75% or even at least 95%, as measured by the method set out here after using a glass-filter with a maximum pore size of 20 microns. Preferred herein are polymeric materials.

50 grams ±0.1 gram of pouch material is added in a pre-weighed 400 ml beaker and 245ml ±1 ml of distilled water is added. This is stirred vigorously on a magnetic stirrer set at 600 rpm, for 30 minutes. Then, the mixture is filtered through a folded qualitative sintered-glass filter with a pore size as defined above (max. 20 micron). The water is dried off from the collected filtrate by any conventional method, and the weight of the remaining material is determined (which is the dissolved or dispersed fraction). Then, the % solubility or dispersability can be calculated.

Preferred polymers, copolymers or derivatives thereof suitable for use as pouch or capsule wall material are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and natural gums such as xanthum and carragum, and gelatines. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Preferably, the level of polymer in the pouch or capsule material, for example a PVA polymer, is at least 60%. Soft gelatin capsules are also preferred for use herein.

The polymer can have any weight average molecular weight, preferably from about 1000 to 1,000,000, more preferably from about 10,000 to 300,000 yet more preferably from about 20,000 to 150,000.

Mixtures of polymers can also be used. This can be beneficial for controlling mechanical and/or dissolution properties. Suitable mixtures include for example mixtures wherein one polymer has a higher water-solubility than another polymer, and/or one polymer has a higher mechanical strength than another polymer. Also suitable are mixtures of polymers having different weight average molecular weights, for example a mixture of PVA or a copolymer thereof of a weight average molecular weight of about 10,000-40,000, preferably around 20,000, and of PVA or copolymer thereof, with a weight average molecular weight of about 100,000 to 300,000, preferably around 150,000.

Also suitable herein are polymer blend compositions, for example comprising hydrolytically degradable and water-soluble polymer blends such as polylactide and polyvinyl alcohol, obtained by mixing polylactide and polyvinyl alcohol, typically comprising about 1-35% by weight polylactide and about 65% to 99% by weight polyvinyl alcohol.

Preferred for use herein are polymers which are from about 60% to about 98% hydrolysed, preferably about 80% to about 90% hydrolysed, to improve the dissolution characteristics of the material.

Most preferred materials are PVA films known under the trade reference Monosol M8630, as sold by Chris-Craft Industrial Products of Gary, Ind., US, and PVA films of corresponding solubility and deformability characteristics. Other films suitable for use herein include films known under the trade reference PT film or the K-series of films supplied by Aicello, or VF-HP film supplied by Kuraray.

The pouch or capsule material herein can also comprise one or more additive ingredients. For example, it can be beneficial to add plasticisers, for example glycerol, ethylene glycol, diethyleneglycol, propylene glycol, sorbitol and mixtures thereof. Other additives include functional detergent additives to be delivered to the wash water, for example organic polymeric dispersants, etc.

### EXAMPLES

Abbreviations Used in Examples

In the examples, the abbreviated component identifications have the following meanings:

| | |
|---|---|
| Carbonate | Anhydrous sodium carbonate |
| STPP | Sodium tripolyphosphate anhydrous |
| (anhydrous) | |
| SKTP | Sodium potassium tripolyphosphate anhydrous |
| STPP | Sodium tripolyphosphate hydrated to approximately 8% |
| (hydrated) | |
| KOH | Potassium hydroxide |
| Silicate | Amorphous Sodium Silicate (SiO₂:Na₂O = from 2:1 to |
| | 4:1) |
| Perborate | Sodium perborate monohydrate |
| PAAN | Pentaamine cobalt (III) acetate dichloride salt |
| FN3 | Protease available from Genencor |
| Natalase | α-amylase available from Novo Nordisk A/S |
| SLF18 | Low foaming surfactant available from BASF |
| ACNI | Alkyl capped non-ionic surfactant of formula C_{9/11} H_{19/23} |
| | EO₈-cyclohexyl acetal |
| C₁₄AO | Tetradecyl dimethyl amine oxide |
| DPM | Dipropylene glycol methyl ether |
| DPG | Dipropylene glycol |
| 2A2MP | 2-amino-2-methyl propanol |
| Methocel | Cellolosic thickener available from Dow Chemical |
| BHT | Butyl hydroxy toluene |
| CaCl2 | Calcium chlorine |
| Proxel GXL | Preservative(1,2-benzisothiazolin-3-one) available from |
| | Zeneca, Inc |
| Polygel DKP | Thickener agent available from 3V Inc. |

In the following examples all levels are quoted as parts by weight.

### Examples 1 to 6

The compositions of examples 1 to 6 are prepared in the following manner: solvent and thermally stable particulate material (i.e., sodium tripolyphosphate, sodium potassium tripolyphosphate, silicate and carbonate) are added to a beaker. The mixture is stirred for 3 minutes using a Cowles mixer blade. The resulting mixture is transferred to a lab-scale Ross emulsifier and ground for 10 minutes. After the 10 minutes the ground mixture is transferred back to the Cowles mixer blade and the mixture is heated, using a hot plate, until it reaches 30° C., at this point the thickener agent is added using the Cowles blade with high stirring speed. Once all the thickener is added, the beaker is removed from the hot plate. The mixture is stirred using the Cowles under high shear for 30 minutes. The mixture is left without stirring for approximately 12 hours. Afterwards, the particulate bleach (whose particle size has been reduced to an average size of about 40 μm using an attritor) and the enzymes are added to the mixture and the new mixture is stirred using the Cowles blade under high stirring speed to fully disperse the particulate bleach and the enzymes. After dispersion the new mixture is stirred for 10 minutes under moderate to high agitation.

| Example | 1 | 2 | 3 | 4 | 5 | 6 |
|---|---|---|---|---|---|---|
| C₁₄AO | 1.50 | 1.54 | 1.55 | 1.54 | 1.0 | |
| ACNI | | 1.93 | | | | |
| SLF18 | 1.93 | | 1.90 | 1.93 | 1.5 | |
| STPP | 21.56 | | 21.48 | 21.52 | 22.0 | 25.0 |
| (anhydrous) | | | | | | |
| SKTP | | 21.52 | | | | |
| (anhydrous) | | | | | | |
| DPM | | | 41.61 | | 40.5 | 62.0 |
| DPG | 41.61 | 41.61 | | | | |
| 2A2MP | | | | 41.61 | | |
| Perborate | 4.34 | 4.34 | 4.34 | 4.34 | 3.5 | 12.395 |
| PAAN | 0.004 | 0.004 | 0.004 | 0.004 | 0.005 | 0.005 |
| Natalase | 0.44 | 0.44 | 0.44 | 0.44 | 0.44 | |
| FN3 | 0.51 | 0.51 | 0.51 | 0.51 | 0.60 | |
| Carbonate | 23.44 | 23.44 | 23.44 | 23.44 | 25.0 | |
| Silicate | 4.27 | 4.27 | 4.27 | 4.27 | 5.0 | |
| BHT | 0.1 | 0.1 | 0.1 | 0.1 | | |
| Methocel | 0.3 | 0.3 | 0.3 | 0.3 | 0.35 | 0.6 |
| Perfume | 1 | 1 | 1 | 1 | 0.105 | |

The compositions display outstanding phase stability (no visual phase separation after 30 days at 48° C.), bleach stability (about 93% of available oxygen retained after 6 weeks at 32° C.), enzyme stability (about 93% of available oxygen retained after 6 weeks at 32° C.) as 5 well as good transport stability.

Compositions of Examples 1 to 6 are used to wash a load of tableware and cookware having cooked-on, baked-on and burnt-on food soils. The load comprises different soils and different substrates: lasagne baked for 2 hours at 140° C. on Pyrex, lasagne cooked for 2 hours at 150° C. on stainless steel, potato and cheese cooked for 2 hours at 150° C. on stainless steel, egg yolk cooked for 2 hours at 150° C. on stainless steel and sausage cooked for 1 hour at 120° C. followed by 1 hour at 180° C. The load is washed in a 5 liter liquor capacity Bosch 6032 dishwashing machine, at 55° C. without prewash, placing 20 ml, in the main wash compartment, of the compositions given in Examples 1 to 6. The compositions provide excellent removal of cooked-on, baked-on and burnt-on food soils.

### Examples 7 to 10

Examples 7 to 10 are dual systems compositions comprising an aqueous composition and an anhydrous composition. The anhydrous compositions are prepared in similar manner to the compositions of Examples 1 to 6. The compositions are stored in a dual compartment bottle and delivered simultaneously into the dishwasher dispenser.

| Example | 7 | 8 | 9 | 10 |
|---|---|---|---|---|
| Aqueous composition | | | | |
| SKTP | | | 30 | 30 |
| STPP (hydrated) | 22 | 22 | | |
| KOH | 10.11 | 16.67 | 5.33 | 5.33 |
| Polygel DKP | 1.16 | 1.0 | 0.9 | 0.9 |
| SLF18 | 1.0 | 2.5 | 3.0 | 3.0 |
| C₁₄AO | | 1.33 | 1.60 | 1.60 |
| ACNI | | | | 3.0 |
| Liquid FN3 | 0.6 | 0.6 | 0.9 | 0.9 |
| Natalase | 0.17 | 0.17 | 0.27 | 0.27 |
| Propylene Glycol | 0.5 | 2.0 | 6.0 | 6.0 |
| Boric acid | 3.0 | 3.0 | 4.0 | 4.0 |
| CaCl₂ | 0.37 | 0.37 | 0.37 | 0.37 |
| Sodium benzoate | 0.61 | 0.61 | 0.61 | 0.61 |
| Proxel GXL | 0.05 | 0.05 | 0.05 | 0.05 |
| Perfume | 0.1 | 0.1 | 0.1 | 0.1 |
| Water | up to 100 | | | |
| Anhydrous composition | | | | |
| C₁₄AO | 1.50 | 1.54 | 1.55 | 1.54 |
| ACNI | | 1.93 | | |
| SLF18 | 1.93 | | 1.90 | 1.93 |
| STPP (anhydrous) | 21.56 | | 21.48 | 21.52 |
| SKTP (anhydrous) | | 21.52 | | |
| DPM | | | 41.61 | |
| DPG | 41.61 | 41.61 | | |
| 2A2MP | | | | 41.61 |
| Perborate | 4.34 | 4.34 | 4.34 | 4.34 |
| PAAN | 0.004 | 0.004 | 0.004 | 0.004 |
| Natalase | 0.44 | 0.44 | 0.44 | 0.44 |
| FN3 | 0.51 | 0.51 | 0.51 | 0.51 |
| Carbonate | 23.44 | 23.44 | 23.44 | 23.44 |
| Silicate | 4.27 | 4.27 | 4.27 | 4.27 |
| BHT | 0.1 | 0.1 | 0.1 | 0.1 |
| Methocel | 0.3 | 0.3 | 0.3 | 0.3 |
| Perfume | 1 | 1 | 1 | 1 |

The anhydrous compositions display outstanding phase stability (no visual phase separation after 30 days at 48° C.), bleach stability (about 93% of available oxygen retained after 6 weeks at 32° C.), enzyme stability (about 93% of available oxygen retained after 6 weeks at 32° C.) as well as good transport stability.

The compositions of Examples 7 to 10 are used to wash a load of tableware/cookware as described in Examples 1 to 6. The compositions provide excellent removal of cooked-on, baked-on and burnt-on food soils.

### Examples 11 to 14

Examples 11 to 14 are anhydrous compositions prepared in similar manner to the compositions of Examples 1 to 6. The compositions are packaged in a single compartment water-soluble PVA pouch (made from Monosol M8630 film as supplied by Chris-Craft Industrial Products) and the resulting product delivered into the dishwasher dispenser.

| Example | 11 | 12 | 13 | 14 | 15 |
|---|---|---|---|---|---|
| C₁₄AO | 0.5 | 5.6 | | | 3.5 |
| C₁₆AO | | | 3.6 | 0.5 | |
| ACNI | 4.6 | | 4.6 | | 2.5 |
| SLF18 | | 5.6 | | 4.6 | |
| STPP (anhydrous) | 34 | 33 | 36 | 34 | 33.50 |
| DPM | 45.2 | | 45.6 | 46.1 | |
| DPG | | 45.5 | | | 42.35 |
| Savinase | | 1.7 | 1.6 | 1.6 | |
| Termamyl | 1.6 | 1.6 | | | |
| Natalase | | | | | 0.85 |
| FN3 | 2.0 | | 1.6 | 1.0 | 0.85 |
| Silicate | | | | | 16.0 |
| Carbonate | 10 | 10 | 10 | 10 | |
| Methocel | 0.5 | 0.5 | 0.5 | 0.4 | 0.25 |
| Perfume | 0.5 | 0.5 | 0.5 | 0.5 | 0.2 |

The anhydrous compositions display outstanding phase stability (no visual phase separation after 30 days at 48° C.), bleach stability (about 93% of available oxygen retained after 6 weeks at 32° C.), enzyme stability (about 93% of available oxygen retained after 6 weeks at 32° C.) as well as good transport stability.

The compositions of Examples 11 to 14 are used to wash a load of tableware/cookware as described in Examples 1 to 6. The compositions provide excellent removal of cooked-on, baked-on and burnt-on food soils.

### Examples 15 to 18

Examples 15 to 18 are anhydrous compositions prepared in similar manner to the compositions of Examples 1 to 6. The compositions are packaged in a single compartment water-soluble PVA pouch (made from Monosol M8630 film as supplied by Chris-Craft Industrial Products) and the resulting product delivered into the dishwasher dispenser.

| Example | 15 | 16 | 17 | 18 |
|---|---|---|---|---|
| C₁₄AO | 1.2 | | | |
| C₁₆AO | | 1.2 | 1.1 | |
| ACNI | 1.1 | 1.1 | | |
| SLF18 | | | 1.1 | |
| LF404 | | | | 2.3 |
| STPP (anhydrous) | 34 | 34 | 34 | 34 |
| Silicate | 8 | 8 | 8 | 8 |
| HEDP | 0.7 | 0.7 | 0.7 | 0.7 |
| Percarbonate | 10 | 10 | 10 | 10 |
| DPM | 30 | | 30 | |
| DPG | | 30 | | 30 |
| Savinase | 0.5 | 0.5 | 0.5 | 0.5 |
| Termamyl | 0.5 | | | 0.5 |
| FN3 | | 0.5 | 0.5 | |
| Carbonate | 13 | 13 | 13 | 13 |
| Methocel | 0.5 | 0.5 | 0.5 | 0.4 |
| Perfume | 0.5 | 0.5 | 0.5 | 0.5 |

The anhydrous compositions display outstanding phase stability (no visual phase separation after 30 days at 48° C.), bleach stability (about 93% of available oxygen retained after 6 weeks at 32° C.), enzyme stability (about 93% of available oxygen retained after 6 weeks at 32° C.) as well as good transport stability.

The compositions of Examples 15 to 18 are used to wash a load of tableware/cookware as described in Examples 1 to 6. The compositions provide excellent removal of cooked-on, baked-on and burnt-on food soils.

In Examples 1 to 18, the DPM and DPG components are replaced with an equal weight of polyethylene glycol having a molecular weight of about 300. The resulting compositions display excellent phase, bleach, enzyme and transport stability. They are also effective in the removal of cooked-on, baked-on and burnt-on food soils.

What is claimed is:

1. An automatic dishwashing composition in the form of an anhydrous, shear-thinning organo solvent-based gel and which comprises a thickening system comprising a non-ionic cellulosic material.

2. An automatic dishwashing composition according to claim 1 wherein the organo solvent has a fractional polar Hansen solubility parameter of from about 10% to about 40% and a fractional dispersion Hansen solubility parameter of from about 20% to about 60%.

3. An automatic dishwashing composition according to claim 1 comprising from about 0.1% to about 1% by weight of composition of the thickening system.

4. An automatic dishwashing composition according to claim 3 wherein the thickening system comprises at least about 80%, by weight, of said non-ionic cellulosic material.

5. An automatic dishwashing composition according to claim 4 wherein the thickening system comprises at least about 95%, by weight, of said non-ionic cellulosic material.

6. An automatic dishwashing composition according to claim 5 wherein said thickening system comprises at least about 99%, by weight, of said non-ionic cellulosic material.

7. An automatic dishwashing composition according to claim 1 wherein the thickening system is soluble in the organo solvent-based gel.

8. An automatic dishwashing composition according to claim 1 wherein the composition comprises a detergent active or auxiliary in the form of a particulate suspension.

9. An automatic dishwashing composition according to claim 8 wherein the detergent active or auxiliary has an average particle size from about 10 to about 100 μm.

10. An automatic dishwashing composition according to claim 9 wherein the detergent active or auxiliary has an average particle size from about 25 to about 75 μm.

11. An automatic dishwashing composition according to claim 8 wherein the detergent active or auxiliary is selected from bleaches, bleach activators, enzymes alkalinity sources, builders, surfactants and mixtures thereof.

12. An automatic dishwashing composition according to claim 8 wherein the detergent active or auxiliary comprises a peroxygen bleaching agent.

13. An automatic dishwashing composition according to claim 12 wherein the peroxygen bleaching agent is selected from the group consisting of inorganic perborates and percarbonates, organic peracids, di-acyl peroxides and mixtures thereof.

14. An automatic dishwashing composition according to claim 1 wherein the anhydrous composition comprises a free radical scavenger selected from the group consisting of benzoic acids, sulfobenzenes and mixtures thereof.

15. An automatic dishwashing composition according to claim 1 wherein the composition has a shear index n (Herschel-Bulkey model) of from about 0.3 to about 0.7.

16. An automatic dishwashing composition according to claim 15 wherein the composition has a shear index n (Herschel-Bulkey model) of from about 0.4 to about 0.6.

17. An automatic dishwashing composition according to claim 1 wherein the composition has a viscosity greater than about 10,000 cP (mPa s) as measured at a shear rate of 1 s⁻¹ and a viscosity less than about 2,000 cP as measured at a shear rate of 150 s⁻¹ at 25° C. using a Rheometrics Dynamic Stress Rheometer with 40 mm parallel plate configuration.

18. An automatic dishwashing composition according to claim 17 wherein the composition has a viscosity greater than about 15,000 cP (mPa s) as measured at a shear rate of 1 s⁻¹ and a viscosity less than about 1,000 cP as measured at a shear rate of 150 s⁻¹ at 25° C. using a Rheometrics Dynamic Stress Rheometer with 40 mm parallel plate configuration.

19. An automatic dishwashing composition according to claim 1 comprising from about 1% to about 99%, by weight, of an organo solvent.

20. An automatic dishwashing composition according to claim 19 wherein the organic solvent or solvent system has a volatile organic content above 1 mm Hg and less than about 20% by weight thereof.

21. An automatic dishwashing composition according to claim 20 wherein the organic solvent or solvent system has a volatile organic content above 0.1 mm Hg and less than about 10% by weight thereof.

22. An automatic dishwashing composition according to claim 1 wherein the organic solvent or solvent system is selected from organoamine solvents, alcoholic solvents, glycols and glycol derivatives and mixtures thereof.

23. An automatic dishwashing composition according to claim 1 wherein the organic solvent or solvent system is selected from C₂-C₃ alkylene, dialkylene, trialkylene and polyalkyleneglycols, glycol ethers and esters thereof, and mixtures thereof.

24. An automatic dishwashing composition according to claim 1 additionally comprising a wetting agent effective in lowering the surface tension of the solvent system to at least 1 mN/m less than that of the wetting agent.

25. An automatic dishwashing composition according to claim 1 wherein the composition comprises an odor masking perfume.

26. An automatic dishwashing composition according to claim 1 having a pH (1% aqueous solution) greater than about 12 as measured at 25° C.

27. An automatic dishwashing composition according to claim 26 having a pH (1% aqueous solution) greater than about 12.5 as measured at 25° C.

28. An automatic dishwashing product in the form of a capsule, pouch or sachet comprising the dishwashing composition according to claim 1.

29. An automatic dishwashing composition according to claim 28 wherein the composition is delivered in the form of a water soluble pouch comprising a unit dose amount of the composition.

30. An automatic dishwashing composition in the form of an anhydrous, shear-thinning organo solvent-based gel comprising:
a) from about 0.1% to about 1%, by weight, of a thickening system comprising a non-ionic cellulosic material;
b) from about 1% to about 99%, by weight, of a detergent active or auxiliary selected from the group consisting of bleaches, bleach activators, enzymes, alkalinity sources, builders, surfactants, perfumes and mixtures thereof; and
c) from about 1% to about 99%, by weight, of an organo solvent; wherein the composition is in the form of a particulate suspension; wherein the thickening system is essentially free of clay-type thickener materials; wherein the composition has a shear index n (Herschel-Bulkey model) of from about 0 to about 0.8; wherein the composition has a viscosity greater than about 8,000 cP (mPa s) and a viscosity less than about 5,000 cP (mPa s); and wherein the composition has a pH (1% aqueous solution) greater than about 11.5 measured at 25° C.

31. An automatic dishwashing composition according to claim 30 comprising:
a) from about 0.1% to about 1%, by weight, of a thickening system comprising at least about 80%, by weight, of a non-ionic cellulosic material;
b) from about 40% to about 80%, by weight, of an organic solvent system;
c) from about 5% to about 25%, by weight, of a bleach;
d) from about 0.0001% to about 10%, by weight, of a detergency enzyme; and
e) from about 25% to about 45%, by weight, of a detergent active or auxiliary selected from the group consisting of bleach activators, alkalinity sources, builders, surfactants, perfumes and mixtures thereof;
wherein the anhydrous gel comprising bleach is in the form of a particulate suspension; wherein the thickening system is essentially free of clay-type thickener materials; wherein the composition has a shear index n (Herschel-Bulkey model) of from about 0.4 to about 0.6; wherein the composition has a viscosity greater than about 15,000 cP (mPa s) and a viscosity less than about 1,000 cP (mPa s); and wherein the composition has a pH (1% aqueous solution) greater than about 12.5 as measured at 25° C.

32. A multi-phase automatic dishwashing product comprising separate but associated portions of anhydrous composition according to claim 1 and an aqueous composition comprising one or more detergency actives or detergency auxiliaries.

33. A multi-phase automatic dishwashing product according to claim 32 wherein the aqueous composition comprises one or more detergency enzymes.

34. A multi-phase automatic dishwashing product according to claim 32 wherein the aqueous composition comprises non-ionic surfactant.

35. A multi-phase automatic dishwashing product according to claim 32 wherein the aqueous composition comprises a perfume.

36. A multi-phase automatic dishwashing product according to any of claim 32 wherein the aqueous composition has a pH from about 8 to about 10 as measured at 25° C.

37. A multi-phase automatic dishwashing product according to any of claim 36 wherein the aqueous composition has a pH from about 9 to about 9.8 as measured at 25° C.

38. A multi-phase automatic dishwashing product according to claim 32 wherein the anhydrous and aqueous compositions are contained in and delivered from a multi-compartment bottle.

39. A multi-phase automatic dishwashing product according to claim 32 wherein the product is contained in and delivered from a multi-compartment pouch.

40. A method of making the dishwashing composition of claim 1, comprising a detergent active or detergent auxiliary in the form of a particulate suspension, the method comprising:
a) mixing the organo solvent with the thickening system to form a shear-thining anhydrous carrier matrix;
b) milling the particulate material in size reduction equipment to an average particle size from about 10 to about 100 μm, and wherein less than 10% of particles are below about 1 μm and less than 10% of particles are above about 150 μm; and
c) thereafter mixing the products of steps a) and b) to obtain a physically stable suspension.

41. The method according to claim 40 wherein the particulate material is milled in the size reduction equipment to an average particle size from about 25 to about 75 μm and wherein less than 10% of particles are below about 5 μm and less than 10% of particles are above about 100 μm.

42. A method of washing cookware/tableware for removing cooked-, baked-, or burnt-on food soil in an automatic dishwashing machine using a composition according to claim 1.
